(19) United States
(12) Patent Application Publication
(10) Pub. No.: US 2018/0178518 A1
(43) Pub. Date: Jun. 28, 2018

(54) METHOD OF MANUFACTURING LIQUID EJECTING HEAD

(71) Applicant: SEIKO EPSON CORPORATION, Tokyo (JP)

(72) Inventors: Yoichi NAGANUMA, Matsumoto (JP); Motoki TAKABE, Shiojiri (JP)

(21) Appl. No.: 15/839,557

(22) Filed: Dec. 12, 2017

(30) Foreign Application Priority Data
Dec. 27, 2016 (JP) 2016-253678

(51) Int. Cl. B41J 2/16

(52) U.S. Cl. CPC B41J 2/1612; B41J 2/1626; B41J 2202/22; B41J 2202/03; B41J 2/1634

(57) ABSTRACT

There is provided a method of manufacturing a liquid ejecting head that includes a communication substrate on which a pressure chamber substrate in which a pressure chamber communicating with a nozzle is formed is stacked. The communication substrate has a concave portion that forms a common liquid chamber that communicates with a plurality of the pressure chambers, a first hole portion constituting a nozzle-side communication flow channel, a second hole portion constituting a supply-side communication flow channel, and a third hole portion constituting an opening portion communicating with the common liquid chamber. The method includes forming a mask layer for forming the concave portion and the first to third hole portions that communicate with the concave portion, forming a preliminary hole in each of the first to the third hole portions, anisotropically etching the concave portion and the first to third hole portions, and removing the mask layer.

The entire disclosure of Japanese Patent Application No. 2016-253678, filed Dec. 27, 2016 is expressly incorporated by reference herein.

### BACKGROUND

### 1. Technical Field

The present invention relates to a method of manufacturing a liquid ejecting head that ejects liquid such as ink.

### 2. Related Art

A liquid ejecting head that ejects liquid from a nozzle by supplying a liquid such as ink to a pressure chamber and causing a pressure change in the liquid in the pressure chamber is formed by stacking a pressure chamber substrate in which a pressure chamber is formed, a flow channel substrate in which a liquid flow channel and a liquid chamber are formed, and the like. For example, a flow channel including a concave portion (step wall surfaces) and hole portions (reservoir portions) is formed in the flow channel substrate (reservoir forming substrate) of JP-A-2007-98813. The flow channel substrate in JP-A-2007-98813 is a substrate composed of silicon, and the flow channel including a concave portion and hole portions is formed by two-step etching. The hole portions are formed by etching in a first step, and the concave portion is formed by etching in a second step.

In the case where a flow channel is formed by etching, a sagging surface is formed at the edge portion of openings of the flow channel and is inclined in such a manner that the openings of the flow channel widen outward. Consequently, when the hole portions and the concave portion are formed by two-step etching as in JP-A-2007-98813, in etching of the concave portion in the second step, the sagging surface at the edge of the openings of the hole portions formed by etching in the first step is further etched and there is a possibility that the openings of the hole portions become further widened.

### SUMMARY

An advantage of some aspects of the invention is that a flow channel having a concave portion and hole portions is formed by one-step etching and sagging of the openings of the hole portions is suppressed.

According to an aspect of the invention, there is provided a method of manufacturing a liquid ejecting head that includes a communication substrate on which a pressure chamber substrate in which a pressure chamber communicating with a nozzle is formed is stacked. The communication substrate has a concave portion that forms a common liquid chamber that communicates with a plurality of the pressure chambers, a first hole portion constituting a nozzle-side communication flow channel that enables the nozzle and the pressure chamber to communicate with each other, a second hole portion constituting a supply-side communication flow channel which enables the common liquid chamber and the pressure chamber to communicate with each other, and a third hole portion constituting an opening portion communicating with the common liquid chamber. The method includes forming a mask layer for forming, in the communication substrate, the concave portion and the first to third hole portions that communicate with the concave portion, forming a preliminary hole in each of the first to third hole portions, anisotropically etching the concave portion and the first to third hole portions, and removing the mask layer. According to the above configuration, in the etching, because the concave portion and the first to third hole portions that communicate with the concave portion are formed by anisotropic etching, the concave portion and the first to third hole portions can be formed by one-step etching. This makes it possible to reduce the number of steps as compared with the case of forming by using two or more steps of etching. In addition, because the flow channel including the concave portion and the hole portions is formed by one-step etching, sagging of the openings of the hole portions can be suppressed as compared with the case where the hole portions are formed by using two or more steps of etching. In addition, because the formation of the preliminary holes in the first to third hole portions is performed before the etching, a portion where formation of a sagging surface due to etching may start can be shifted from the edge portion of the openings of the first to third hole portions to the edge portion of the openings of the preliminary holes inside the hole portions. That is, because a sagging surface starts to be formed from the openings of the preliminary holes, even if a sagging surface is formed, until the sagging surface reaches the edge portion of the openings of the first to third hole portions, sagging of the openings of the hole portions due to etching can be suppressed because etching in the depth direction of the first to third hole portions progresses to a larger extent. As described above, according to this aspect, it is possible to form the flow channel including the concave portion and the hole portions by one-step etching and to suppress sagging of the openings of the hole portions.

It is preferable that the preliminary hole be a through hole penetrating in the plate thickness direction from the first surface of the communication substrate to the second surface opposing the first surface. According to the above configuration, in the etching of the first to third hole portions, etching proceeds from the openings of both the first surface and the second surface through which the through holes as the preliminary holes penetrate. Consequently, because etching proceeds from both the first surface and the second surface in the depth direction, compared with the case where etching proceeds from only one surface, it is possible to shorten the etching time for forming the first to third hole portions. Therefore, as the etching time becomes shorter, sagging can be suppressed more than in the case where etching proceeds from only one surface.

It is preferable that in the preliminary hole forming, a plurality of the through holes be formed in at least one of the first to third hole portions. According to the above configuration, in the preliminary hole forming, because a plurality of through holes as the preliminary holes are formed in at least one of the first to third hole portions, in the etching, etching proceeds from the plurality of through holes. Therefore, the etching time can be made shorter than in the case where the number of through holes is one.

It is preferable that in the preliminary hole forming, the at least one of the first to third hole portions have the plurality of the through holes in which at least one through hole is formed at each end portion of the at least one hole portion in the radial direction. According to the above configuration, because at least one through hole is formed at each end portion of the at least one hole portion having a plurality of through holes in the radial direction and consequently etching proceeds obliquely inward from each of the opening end portions of the through holes, sagging is hardly formed at both end portions of the hole portion. Therefore, it is possible to form the hole portion deeply.

It is preferable that in the preliminary hole forming, the at least one through hole be further formed in the central portion of the at least one hole portion. According to the above configuration, because etching progresses not only from the through holes at both end portions of the hole portions but also from the through hole at the central portion, the etching time can be shortened.

It is preferable that in the preliminary hole forming, the preliminary hole be formed by laser processing or deep reactive ion etching (Deep RIE). According to the above configuration, in the preliminary hole forming, because the preliminary hole is formed by laser processing, the preliminary hole can be formed easily.

It is preferable that in the preliminary hole forming, a portion where the preliminary hole is to be formed be marked before the preliminary hole is formed by the laser processing. According to the above configuration, in the preliminary hole forming, because marking (for example, formation of a dimple) is performed on a portion where the preliminary hole is to be formed before forming the preliminary hole by laser processing, the position of the preliminary hole to be formed by laser processing can be easily confirmed.

### BRIEF DESCRIPTION OF THE DRAWINGS

The invention will be described with reference to the accompanying drawings, wherein like numbers reference like elements.

FIG. 1 is a partial schematic view of a liquid ejecting apparatus according to a first embodiment of the invention.

FIG. 2 is an exploded perspective view of a liquid ejecting head.

FIG. 3 is a cross-sectional view taken along line III-III illustrated in FIG. 2.

FIG. 4 is a partial cross-sectional perspective view of a communication substrate.

FIG. 5A is a cross-sectional view illustrating a mask layer forming step in a method of manufacturing a liquid ejecting head.

FIG. 5B is a cross-sectional view illustrating a preliminary hole forming step in the method of manufacturing a liquid ejecting head.

FIG. 5C is a cross-sectional view illustrating an etching step in the method of manufacturing a liquid ejecting head.

FIG. 5D is a cross-sectional view illustrating a mask layer removing step in the method of manufacturing a liquid ejecting head.

FIG. 6 is a cross-sectional view for explaining the progression of the etching step.

FIG. 7 is a plan view of a communication substrate in a liquid ejecting head of a second embodiment.

FIG. 8 is a cross-sectional view taken along line VIII-VIII in FIG. 7.

### DESCRIPTION OF EXEMPLARY EMBODIMENTS

### First Embodiment

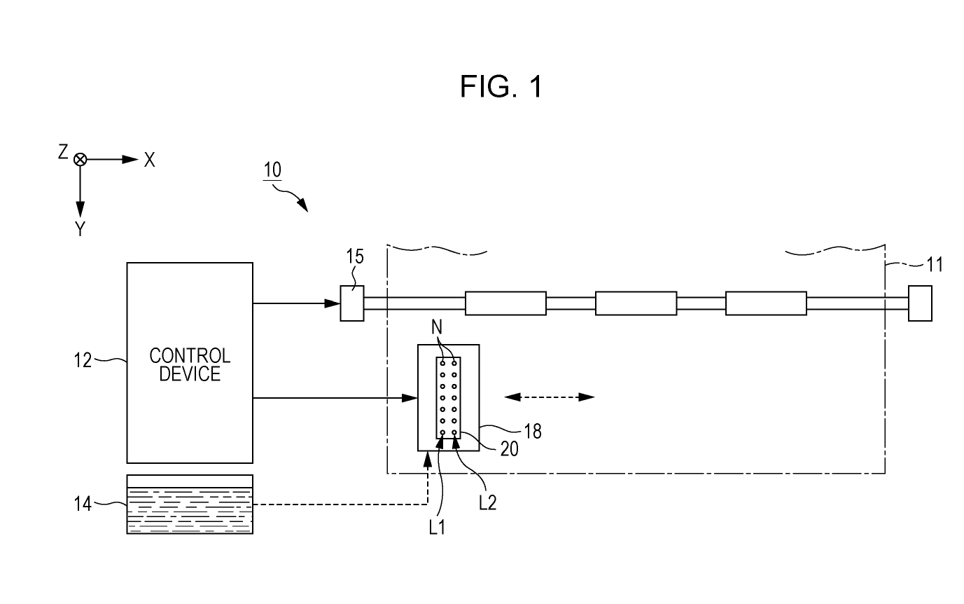

FIG. 1 is a partial schematic view of a liquid ejecting apparatus 10 according to a first embodiment of the invention. The liquid ejecting apparatus 10 of the first embodiment is an ink-jet-type printing apparatus that ejects ink, which is an example of a liquid, onto a medium 11 such as printing paper. The liquid ejecting apparatus 10 illustrated in FIG. 1 includes a control device 12, a transport mechanism 15, a carriage 18, and a liquid ejecting head 20. A liquid container 14 for storing ink is mounted in the liquid ejecting apparatus 10.

The liquid container 14 is an ink-tank-type cartridge formed of a box-shaped container that is detachable from the main body of the liquid ejecting apparatus 10. Further, it should be noted that the liquid container 14 is not limited to a box-shaped container and may be an ink-pack-type cartridge formed of a bag-shaped container. Ink is stored in the liquid container 14. The ink may be black ink or color ink. The ink stored in the liquid container 14 is pressure-fed by a pump (not illustrated) to the liquid ejecting head 20.

The control device 12 integrally controls each component of the liquid ejecting apparatus 10. The transport mechanism 15 transports the medium 11 in the Y direction under the control of the control device 12. The liquid ejecting head 20 ejects the ink supplied from the liquid container 14 to the medium 11 from each of a plurality of nozzles N under the control of the control device 12.

The liquid ejecting head 20 is mounted on the carriage 18. In FIG. 1, the case where one liquid ejecting head 20 is mounted on the carriage 18 has been exemplified, but the invention is not limited thereto, and a plurality of the liquid ejecting heads 20 may be mounted on the carriage 18. The control device 12 causes the carriage 18 to reciprocate in the X direction, which crosses the Y direction (orthogonal in FIG. 1). A desired image is formed on the surface of the medium 11 by the liquid ejecting head 20 ejecting ink onto the medium 11 while the medium 11 is being transported and the carriage 18 is reciprocating. Further, a plurality of the liquid ejecting heads 20 may be mounted on the carriage 18. Further, the direction perpendicular to the XY plane (the plane which is parallel to the surface of the medium 11) is referred to as the Z direction.

### Liquid Ejecting Head

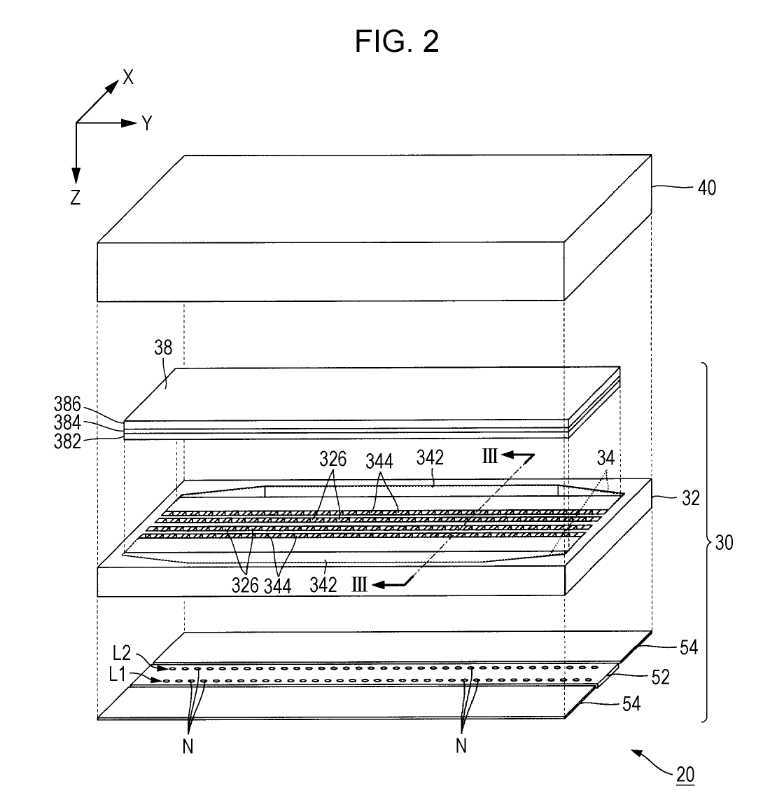

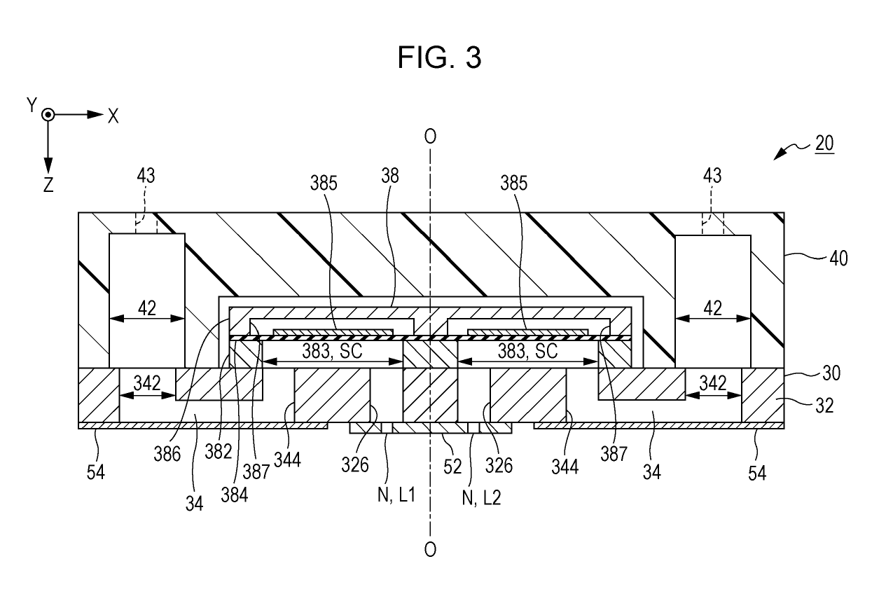

FIG. 2 is an exploded perspective view of the liquid ejecting head 20. FIG. 3 is a cross-sectional view of the liquid ejecting head 20 taken along line III-III illustrated in FIG. 2. As illustrated in FIGS. 2 and 3, the liquid ejecting head 20 is formed by fixing (joining) a case member 40 to a head main body 30 having a discharge surface on which nozzles N for discharging ink are formed. The head main body 30 includes a communication substrate 32. A nozzle plate 52 on which a plurality of nozzles N are formed and sealing plates 54 (compliance substrates) are installed on one side of the communication substrate 32 (the positive-side surface in the Z direction) and a multilayer portion 38 including a pressure chamber substrate 382 is stacked on the other side of the communication substrate 32 (the negative-side surface in the Z direction). The respective elements of the head main body 30 are fixed to each other by, for example, an adhesive.

The nozzle plate 52 is a flat plate material constituting an ejection surface on which a plurality of nozzles N arranged in the Y direction (first direction) are formed. The nozzle plate 52 is formed of, for example, a silicon material. The plurality of nozzles N are formed of two rows of nozzle rows L1 and L2. Each of the nozzle rows L1 and L2 is a group of a plurality of nozzles N arranged along the Y direction. Further, the arrangement of the nozzle rows L1 and L2 is not limited to that illustrated in this embodiment. For example, the nozzle rows L1 and L2 may be arranged shifted with respect to each other in the Y direction. In addition, the number of nozzle rows formed in the nozzle plate 52 is not limited to two, and may be one row.

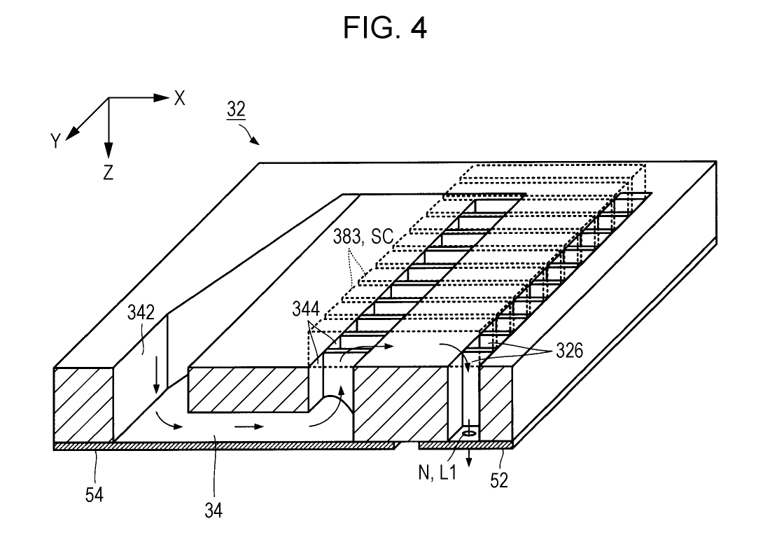

In the liquid ejecting head 20 according to this embodiment, the structure corresponding to the nozzle row L1 (the left-side portion in FIG. 3) and the structure corresponding to the nozzle row L2 (the right-side portion in FIG. 3) are formed substantially line-symmetrical with respect to the X-direction virtual line O-O and both structures are substantially the same. Therefore, in the following description, attention is paid to the structure corresponding to the nozzle row L1 (the portion to the left side of the virtual line O-O in FIG. 3), and the description of the elements corresponding to the nozzle row L2 will be omitted for the sake of convenience. FIG. 4 is a partial cross-sectional perspective view of a structure corresponding to the nozzle row L1. In FIG. 4, a plurality of pressure chambers SC are indicated by broken lines.

The communication substrate 32 illustrated in FIGS. 2 to 4 is a flat plate-shaped flow channel substrate constituting a flow channel of ink. The communication substrate 32 is composed of, for example, a silicon material. A common liquid chamber 34 and a plurality of nozzle-side communication flow channels 326 are formed in the communication substrate 32. The common liquid chamber 34 includes an inflow opening 342 into which the ink flows and a plurality of supply-side communication flow channels 344. The plurality of supply-side communication flow channels 344 and the plurality of nozzle-side communication flow channels 326 are through holes respectively formed for the nozzles N and the common liquid chamber 34 is an opening shared by the plurality of nozzles N.

Each of the sealing plates 54 is a flexible film and functions as a vibration absorbing body that absorbs pressure fluctuations of the ink in the common liquid chamber 34. As illustrated in FIG. 3, the sealing plate 54 seals the common liquid chamber 34 and forms the bottom surface of the common liquid chamber 34. Further, in FIG. 3, the case where the common liquid chamber 34 corresponding to the nozzle row L1 and the common liquid chamber 34 corresponding to the nozzle row L2 are sealed by the sealing plates 54 that are separate has been described, but the invention is not limited to this and one sealing plate 54 may be made to be continuous over both of the common liquid chambers 34.

The multilayer portion 38 is formed by stacking the pressure chamber substrate 382, a diaphragm 384, and a protective plate 386, which form pressure chambers SC that communicate with the nozzles N, in this order. However, the invention is not limited to such a configuration, and the multilayer portion 38 may be formed without the protective plate 386. A plurality of opening portions 383 that respectively form each of the pressure chambers SC (cavities) that communicate with the nozzles N are formed in the pressure chamber substrate 382. The pressure chamber substrate 382 is composed of, for example, a silicon material similarly to the communication substrate 32.

The diaphragm 384 is installed on the surface of the pressure chamber substrate 382 that is on the opposite side to the communication substrate 32. The diaphragm 384 is a flat plate material capable of vibrating elastically. The diaphragm 384 and the communication substrate 32 face each other at certain intervals inside the respective opening portions 383 formed in the pressure chamber substrate 382. Each of the pressure chambers SC that generate a pressure for ejecting ink from the nozzles N is formed of a space interposed between the communication substrate 32 and the diaphragm 384 inside the opening portion 383 of the pressure chamber substrate 382. Each of the supply-side communication flow channels 344 of the communication substrate 32 enables the common liquid chamber 34 described later and the pressure chamber SC to communicate with each other, and each of the nozzle-side communication flow channels 326 of the communication substrate 32 enables the pressure chamber SC and the nozzle N to communicate with each other.

A plurality of piezoelectric elements 385 corresponding to different nozzles N (pressure chambers SC) are formed on the surface of the diaphragm 384 that is on the opposite side to the pressure chamber substrate 382.

Each of the piezoelectric elements 385 is a vibration element interposed between opposing electrodes. Each of the piezoelectric elements 385 individually vibrates by a drive signal supplied from the control device 12. The protective plate 386 is an element for protecting each of the piezoelectric elements 385, and is fixed to the surface of the pressure chamber substrate 382 (the diaphragm 384) by, for example, an adhesive. Each of the piezoelectric elements 385 is housed in a concave portion 387 formed in the surface of the protective plate 386 on the diaphragm 384 side. When each of the piezoelectric elements 385 vibrates in accordance with a drive signal supplied from the control device 12, the diaphragm 384 vibrates in conjunction with the piezoelectric element 385. Consequently, the pressure of the ink in the pressure chamber SC changes and ink is ejected from the nozzle N. In this way, the piezoelectric element 385 functions as a pressure-generating element that changes the pressure in the pressure chamber SC and causes the ink in the pressure chamber SC to be ejected from the nozzle N. Further, the piezoelectric element 385 is connected to the control device 12 via a flexible printed cable (flexible printed circuit: FPC) (not illustrated) or a chip on film (chip on film: COF).

The positive-side surface of the case member 40 in the Z direction (hereinafter referred to as “bonding surface”) is fixed to the negative-side surface of the communication substrate 32 in the Z direction by, for example, an adhesive. The case member 40 is formed of a molding resin material such as a plastic material. When the case member 40 is formed of a molding resin material, it can be integrally molded by injection molding of the molding resin material. The case member 40 is a case for storing ink to be supplied to the plurality of pressure chambers SC, and is a structure body in which a liquid storage chamber 42 is formed, the liquid storage chamber 42 communicating with the common liquid chamber 34 via the inflow opening 342 serving as an opening portion. The liquid storage chamber 42 communicates with an introduction opening 43 that introduces ink.

The common liquid chamber 34 and the liquid storage chamber 42 are spaces shared by a plurality of nozzles N, and store the ink that has been supplied from the liquid container 14 to the introduction opening 43. The common liquid chamber 34 is formed of a space that is elongated in the Y direction. The common liquid chamber 34 of this embodiment has such a shape that the flow channel expands from the inflow opening 342 to the supply-side communication flow channels 344 (outflow opening). The plurality of pressure chambers SC are arranged in one direction (Y direction), and the plurality of supply-side communication flow channels 344 are arranged in the Y direction along the arrangement of the plurality of pressure chambers SC.

As illustrated in FIG. 4, the ink flowing into the common liquid chamber 34 from the liquid storage chamber 42 is branched into the plurality of supply-side communication flow channels 344 and supplied in parallel to the respective pressure chambers SC to be filled. Then, due to the pressure fluctuation corresponding to the vibration of the diaphragm 384, the ink passes from the pressure chambers SC through the nozzle-side communication flow channels 326 and the nozzles N and is discharged to the outside. That is, the pressure chambers SC function as spaces for generating pressure for discharging the ink from the nozzles N, and the common liquid chamber 34 and the liquid storage chamber 42 function as spaces (reservoirs) that store ink to be supplied to the plurality of pressure chambers SC.

### Method of Manufacturing Liquid Ejecting Head

Next, a method of manufacturing the liquid ejecting head 20 according to the first embodiment will be described with reference to the drawings. The method of manufacturing the liquid ejecting head 20 includes a manufacturing method for forming a flow channel in the communication substrate 32. Here, the manufacturing method for forming a flow channel in the communication substrate 32 will be described in detail.

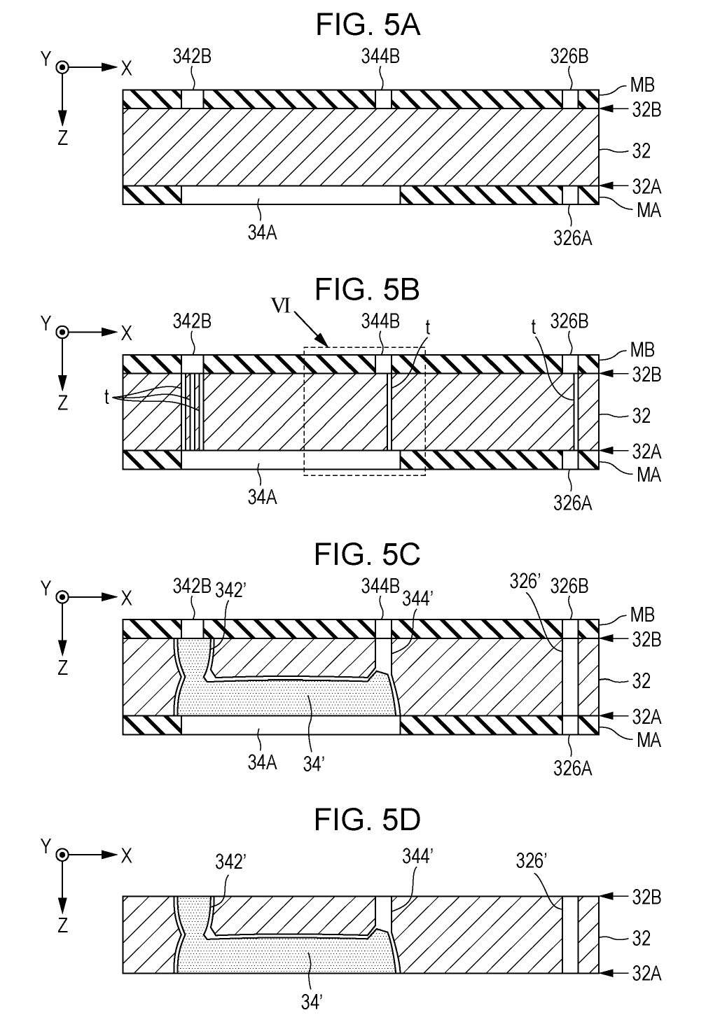

FIGS. 5A to 5D are process diagrams of a manufacturing method for forming a flow channel in the communication substrate 32 according to the first embodiment. In the manufacturing method of this embodiment, flow channels including holes and concave portions are formed by performing anisotropic wet etching on the communication substrate 32 formed of a silicon material. The communication substrate 32 is a silicon single-crystal substrate having a crystal plane orientation of the (110) plane on the surface. The surface on the lower side (the negative side in the Z direction) of the communication substrate 32 is defined as a first surface 32A and the surface on the upper side (the positive side in the Z direction) is defined as a second surface 32B.

In the manufacturing method of this embodiment, the flow channel formed in the communication substrate 32 includes a concave portion 34′ constituting the common liquid chamber 34, a first hole portion 326′ constituting the nozzle-side communication flow channel 326, and a second hole portion 344′ constituting the supply-side communication flow channel 344, and a third hole portion 342′ constituting the inflow opening 342 as an opening portion. FIGS. 5A to 5D are process diagrams illustrating a partial cross-sectional view of a structure corresponding to the nozzle row L1 illustrated in FIG. 3 (to the left of the imaginary line O-O in FIG. 3). In FIGS. 5A to 5D, the structure corresponding to the nozzle row L2 illustrated in FIG. 3 (to the right of the imaginary line O-O in FIG. 3) is omitted.

The manufacturing method of this embodiment is performed in the order of a mask layer forming step (FIG. 5A), a preliminary hole forming step (FIG. 5B), an etching step (FIG. 5C), and a mask layer removing step (FIG. 5D). FIG. 5A is a process diagram of the mask layer forming step. First, in the mask layer forming step illustrated in FIG. 5A, mask layers MA and MB are formed in order to form the concave portion 34′, the first hole portion 326′, the second hole portion 344′, and the third hole portion 342′ in the communication substrate 32 formed of a silicon single-crystal substrate. The mask layers MA and MB are layers serving as masks for etching solutions, such as silicon oxide films and nitride films.

The mask layer MA is formed on the first surface 32A of the communication substrate 32 and the mask layer MB is formed on the second surface 32B of the communication substrate 32. In the mask layer MA, opening portions 34A and 326A for respectively forming the concave portion 34′ and the first hole portion 326′ from the first surface 32A side are formed. Opening portions 326B, 344B, and 342B for respectively forming the first hole portion 326′, the second hole portion 344′, and the third hole portion 342′ from the second surface 32B side are formed in the mask layer MB.

Next, in the preliminary hole forming step illustrated in FIG. 5B, the preliminary holes t of the first hole portion 326′, the second hole portion 344′, and the third hole portion 342′ are formed. The preliminary holes t are through holes that penetrate in the thickness direction from the first surface 32A of the communication substrate 32 to the second surface 32B opposing the first surface 32A. The preliminary holes t are formed by laser processing. Specifically, through holes are formed by irradiating laser light to the portions where the holes t are to be formed. Because the preliminary holes t are formed by laser processing, the preliminary holes t can be easily formed. In this embodiment, the case where the preliminary holes t are formed by laser processing has been exemplified, but it is not limited thereto, and the preliminary holes t may be formed by deep reactive ion etching (Deep RIE) such as the BOSH method or the like. Deep reactive ion etching (Deep RIE) is one type of reactive ion etching (RIE), which is reactive ion etching with a high aspect ratio (narrow and deep).

Further, it should be noted that marking may be performed on portions where the preliminary holes t are to be formed before forming the preliminary holes t by laser processing. As the markings, for example, dimples are formed. As described above, by marking portions where the preliminary holes t are to be formed before forming the preliminary holes t by laser processing, the position of the preliminary holes t to be formed by laser processing can be easily confirmed. The markings are not limited to dimples. In addition, the preliminary holes t are not limited to being formed by laser processing, and the preliminary holes t may be formed by dry etching, the Bosch process, or the like. The preliminary hole t of the first hole portion 326′ and the preliminary hole t of the second hole portion 344′ are formed, and a plurality of preliminary holes t of the third hole portion 342′ are formed. In this way, by performing etching after forming the preliminary holes t, the etching time can be shortened while suppressing sagging due to etching.

Next, in the etching step illustrated in FIG. 5C, anisotropic wet etching is performed using the mask layers MA and MB as masks. For example, etching is performed by exposing the communication substrate 32 to an etching solution composed of an aqueous solution of potassium hydroxide (KOH). Consequently, the first hole portion 326′, the second hole portion 344′, and the third hole portion 342′ are formed so that the flow channel diameter of the preliminary holes t is widened, and at the same time the concave portion 34′ is also formed.

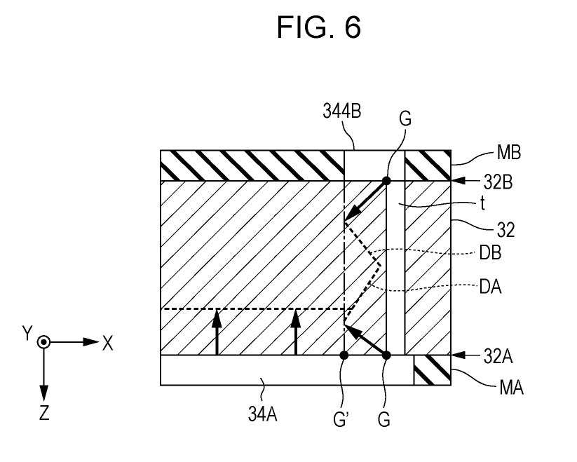

FIG. 6 is a cross-sectional view for explaining the progression of the etching step. FIG. 6 is an enlarged view of a portion VI in FIG. 5B including a portion where the concave portion 34′ and the second hole portion 344′ are formed. As illustrated in FIG. 6, in the etching process of this embodiment, etching of the concave portion 34′ and etching of the second hole portion 344′ simultaneously progress as indicated by arrows in FIG. 6. In addition, because the preliminary hole forming step for forming the preliminary holes t is performed before the etching step, sagging of the opening of the second hole portion 344′ can be suppressed.

In the case of forming a flow channel by wet etching, sagging surfaces DA and DB that are inclined are formed in such a manner that the openings widen outward at the edge of the openings of the flow channel. By forming the preliminary holes t before the etching step, the portion where the formation of the sagging surfaces DA and DB starts is formed from the edge G′ of the openings of the second hole portion 344′ to the edge G of the openings of the preliminary hole t which is inside the opening of the second hole portion 344′. Therefore, because the sagging surfaces DA and DB start to be formed from the openings of the preliminary holes t, even if the sagging surfaces DA and DB are formed, the sagging surfaces DA and DB are formed at the edge of the openings of the second hole portion 344′, and because the etching in the depth direction of the concave portion 34′ advances considerably up until the sagging surfaces DA and DB reach the edge of the openings of the second hole portion 344′, sagging of the opening of the second hole portion 344′ by etching can be suppressed. Similarly, sagging can be suppressed in the first hole portion 326′and the third hole portion 342′. In this manner, because sagging can be reduced, the depth (the length in the plate thickness direction) of the first hole portion 326′, the second hole portion 344′, and the third hole portion 342′ can be formed deep. As a result, the inertance on the supply-side can be stabilized.

As described above, according to the manufacturing method of this embodiment, because the flow channel including the concave portion 34′, the first hole portion 326′, the second hole portion 344′, and the third hole portion 342′ can be formed by one-step etching, it is possible to reduce the number of steps as compared with the case of forming the flow channel with two or more steps of etching. Consequently, the manufacturing cost of the liquid ejecting head 20 can be reduced and the manufacturing time can also be shortened.

If the hole portions and the concave portion are formed by two-step etching, in etching of the concave portion in the second step, etching of the sagging surface at the edge of the openings of the hole portions formed by etching in the first step is further performed and there is a possibility that the openings of the hole portions become further widened. According to the manufacturing method of this embodiment, it is possible to suppress sagging of the openings of the hole portions by forming the flow channel including the concave portion and the hole portions by one-step etching.

In addition, in the etching of the first hole portion 326′, the second hole portion 344′, and the third hole portion 342′, the etching proceeds through openings of both of the first surface 32A and the second surface 32B through which through holes serving as the preliminary holes t penetrate. Consequently, because etching proceeds in the depth direction from both the first surface 32A and the second surface 32B, the etching time for forming the first hole portion 326′, the second hole portion 344′, and the third hole portion 342′ can be shortened more than the case where etching proceeds from only one surface. Therefore, as the etching time becomes shorter, sagging can be suppressed more than in the case where etching proceeds from only one surface.

In the preliminary hole forming step, since a plurality of through holes are formed as the preliminary holes t of the third hole portion 342′, etching progresses from a plurality of through holes in the etching process. Therefore, the etching time can be made shorter than in the case where the number of through holes is one. In FIG. 5B, the case where three through holes are formed as the preliminary holes t of the third hole portion 342′ is exemplified. Specifically, the preliminary holes t of the third hole portion 342′ constitute one through hole at each end portion in the radial direction (X direction) and one through hole at the center portion. In this way, because one through hole is formed at each of the radial end portions of the third hole portion 342′ and consequently etching proceeds obliquely inward from each of the opening end portions of the through holes, it is difficult for sagging to be formed at both end portions of the hole portion. Therefore, it is possible to form the hole portion deeply. In addition, because the preliminary hole t is also formed in the central portion of the third hole portion 342′ and consequently etching progresses also from the through hole in the center portion, the etching time can be shortened.

In addition, by forming the through holes as the preliminary holes t before the etching, it is possible to prevent the crystal face (111), which inhibits penetration by etching, from appearing. As a result, the opening width of the hole portions can be reduced. Therefore, the entirety of the liquid ejecting head 20 can be reduced in size.

Next, in the mask layer removing step illustrated in FIG. 5D, the mask layers MA and MB are removed by etching. Thus, the series of steps of manufacturing the communication substrate 32 is completed. According to the manufacturing method of this embodiment, it is possible to form all of the concave portion 34′, the first hole portion 326′, the second hole portion 344′, and the third hole portion 342′ in the communication substrate 32 by one-step etching and it is possible to suppress sagging of the openings of the first hole portion 326′, the second hole portion 344′, and the third hole portion 342′. Further, according to the manufacturing method of this embodiment, it is possible to form not only the structure corresponding to the nozzle row L2 illustrated in FIG. 3 (to the right of the imaginary line O-O in FIG. 3), but also, the concave portion 34′, the first hole portion 326′, the second hole portion 344′, and the third hole portion 342′ of the structure corresponding to the nozzle row L1 illustrated in FIG. 3, (the left side of the imaginary line O-O in FIG. 3) by etching as illustrated in FIGS. 5A to 5D.

### Second Embodiment

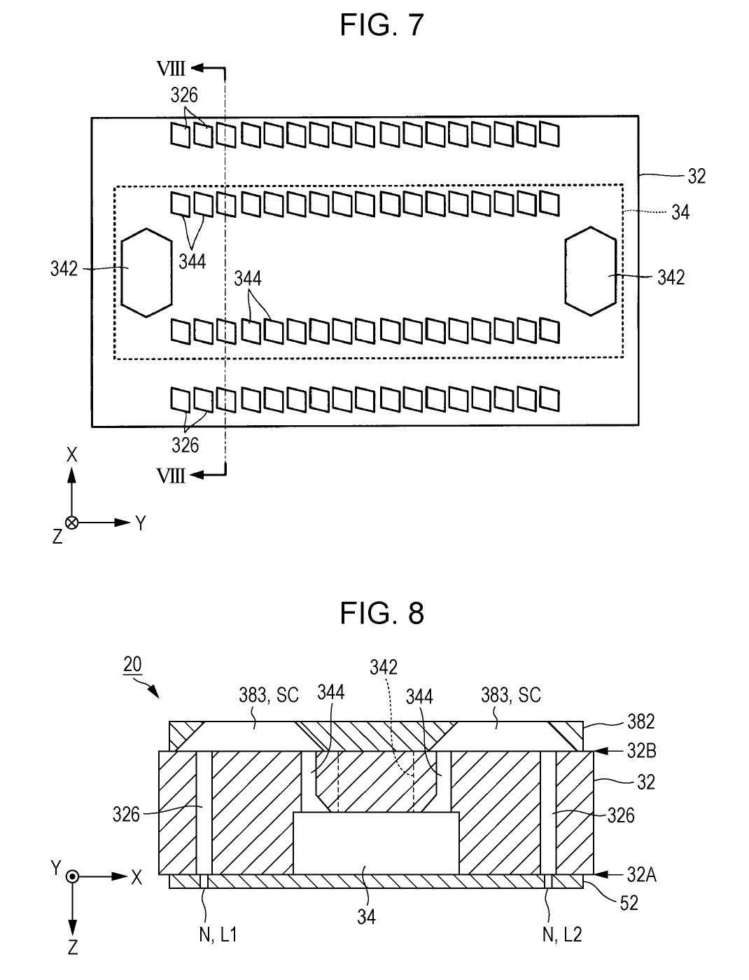

A second embodiment of the invention will be described. Elements of each of the embodiments given below that have the same operations and functions as those of the first embodiment are designated by the same reference symbols as used in the description of the first embodiment and detailed description thereof is omitted. FIG. 7 is a plan view of the communication substrate 32 of the liquid ejecting head 20 according to the second embodiment as seen from above (Z direction), and FIG. 8 is a cross-sectional view taken along line VIII-VIII illustrated in FIG. 7.

As illustrated in FIGS. 7 and 8, the liquid ejecting head 20 of the second embodiment has a structure (the left side portion in FIG. 8) corresponding to the nozzle row L1 and a structure (the right side portion in FIG. 8) corresponding to the nozzle row L2 which share the common liquid chamber 34. The inflow openings 342 of the common liquid chamber 34 are arranged at the negative-side and positive-side end portions of the common liquid chamber 34 in the Y direction. The manufacturing method of the first embodiment can also be applied to the communication substrate 32 of the liquid ejecting head 20 having such a configuration.

By performing the steps of FIGS. 5A to 5D, the concave portion forming the common liquid chamber 34, the nozzle-side communication flow channels 326, the supply-side communication flow channels 344, and the inflow openings 342 of the second embodiment can all be formed in the communication substrate 32 by one step of etching and sagging of the opening of the hole portions can also be suppressed.

### Modifications

The above-described embodiments can be modified in various ways. Specific examples of the modifications will be described below. Two or more examples arbitrarily chosen from the following examples can be combined appropriately as long as they do not contradict each other.

(1) In the above-described embodiment, a serial head that reciprocates the carriage 18 on which the liquid ejecting head 20 is mounted in the X direction is exemplified; however, the invention can also be applied to a line head in which the liquid ejecting head 20 is arranged over the entire width of the medium 11.

(2) In the above-described embodiment, the liquid ejecting head 20 of the piezoelectric type using a piezoelectric element as a drive element for applying mechanical vibration to the pressure chamber is exemplified; however, it is also possible to adopt a thermal-type liquid ejecting head using a heat-generating element that generates bubbles inside the pressure chamber by heating.

(3) The liquid ejecting apparatus exemplified in the above-described embodiment can be adopted for various apparatuses such as a facsimile apparatus and a copying machine in addition to apparatuses dedicated for printing. However, the use of the liquid ejecting apparatus of this invention is not limited to printing. For example, a liquid ejecting apparatus that ejects a solution of color materials can be used as a manufacturing device for forming the color filters of liquid crystal displays. Moreover, a liquid ejecting apparatus that ejects a solution of conductive materials can be used as a manufacturing device for forming wiring or electrodes of a wiring substrate or the like.

What is claimed is:

1. A method of manufacturing a liquid ejecting head that includes a communication substrate on which a pressure chamber substrate in which a pressure chamber communicating with a nozzle is formed is stacked, the communication substrate having a concave portion that forms a common liquid chamber that communicates with a plurality of the pressure chambers, a first hole portion constituting a nozzle-side communication flow channel that enables the nozzle and the pressure chamber to communicate with each other, a second hole portion constituting a supply-side communication flow channel which enables the common liquid chamber and the pressure chamber to communicate with each other, and a third hole portion constituting an opening portion communicating with the common liquid chamber, the method comprising:
forming a mask layer for forming, in the communication substrate, the concave portion and the first to third hole portions that communicate with the concave portion;
forming a preliminary hole in each of the first to third hole portions;
anisotropically etching the concave portion and the first to third hole portions; and
removing the mask layer.

2. The method of manufacturing a liquid ejecting head according to claim 1, wherein
the preliminary hole is a through hole penetrating in a plate thickness direction from a first surface of the communication substrate to a second surface opposing the first surface.

3. The method of manufacturing a liquid ejecting head according to claim 2, wherein
in the preliminary hole forming, a plurality of the through holes are formed in at least one of the first to third hole portions.

4. The method of manufacturing a liquid ejecting head according to claim 3, wherein,
in the preliminary hole forming, the at least one of the first to third hole portions has the plurality of the through holes in which at least one through hole is formed at each end portion of the at least one hole portion in a radial direction.

5. The method of manufacturing a liquid ejecting head according to claim 4, wherein,
in the preliminary hole forming, the at least one through hole is further formed in a central portion of the at least one hole portion.

6. The method of manufacturing a liquid ejecting head according to claim 1, wherein,
in the preliminary hole forming, the preliminary hole is formed by laser processing or deep reactive ion etching.

7. The method of manufacturing a liquid ejecting head according to claim 6, wherein,
in the preliminary hole forming, a portion where the preliminary hole is to be formed is marked before the preliminary hole is formed by the laser processing.
